(19) United States
(12) Patent Application Publication
(10) Pub. No.: US 2018/0105093 A1
(43) Pub. Date: Apr. 19, 2018

(54) Cargo Strap System

(71) Applicants: Clint Wood, Chaska, MN (US); Jerret R. Wood, Sioux Falls, SD (US)

(72) Inventors: Clint Wood, Chaska, MN (US); Jerret R. Wood, Sioux Falls, SD (US)

(21) Appl. No.: 15/295,392

(22) Filed: Oct. 17, 2016

(51) Int. Cl. B60P 7/08

(52) U.S. Cl. CPC B60P 7/083; B60P 7/0853

(57) ABSTRACT

A cargo strap system for inhibiting a cargo strap from flying freely on a vehicle includes a vehicle. The vehicle selectively supports an object thereby facilitating the object to be transported. At least one cargo strap is removably coupled to the vehicle. The at least one cargo strap is selectively extended over the object thereby securing the object to the vehicle. The at least one cargo strap has a free end when the at least one cargo strap is extended over the object. A retention unit is removably coupled to the at least one cargo strap. The retention unit engages the free end of the cargo strap. Thus, the retention unit inhibits the free end from flying freely when the vehicle is driven.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to strap devices and more particularly pertains to a new strap device for inhibiting a loose end of a cargo strap from dangling freely on a vehicle.

### BRIEF SUMMARY OF THE INVENTION

An embodiment of the disclosure meets the needs presented above by generally comprising a vehicle. The vehicle selectively supports an object thereby facilitating the object to be transported. At least one cargo strap is removably coupled to the vehicle. The at least one cargo strap is selectively extended over the object thereby securing the object to the vehicle. The at least one cargo strap has a free end when the at least one cargo strap is extended over the object. A retention unit is removably coupled to the at least one cargo strap. The retention unit engages the free end of the cargo strap. Thus, the retention unit inhibits the free end from flying freely when the vehicle is driven.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a retention unit of a cargo strap system according to an embodiment of the disclosure.

FIG. 2 is a back view of a retention unit of an embodiment of the disclosure.

FIG. 3 is a left side view of retention unit of an embodiment of the disclosure.

FIG. 4 is a perspective view of cargo strap of an embodiment of the disclosure.

FIG. 5 is a rear perspective in-use view of an embodiment of the disclosure.

FIG. 6 is a perspective in-use view of an embodiment of the disclosure.

FIG. 7 is a cross sectional view taken along line 7-7 of FIG. 6 of an embodiment of the disclosure.

### DETAILED DESCRIPTION OF THE INVENTION

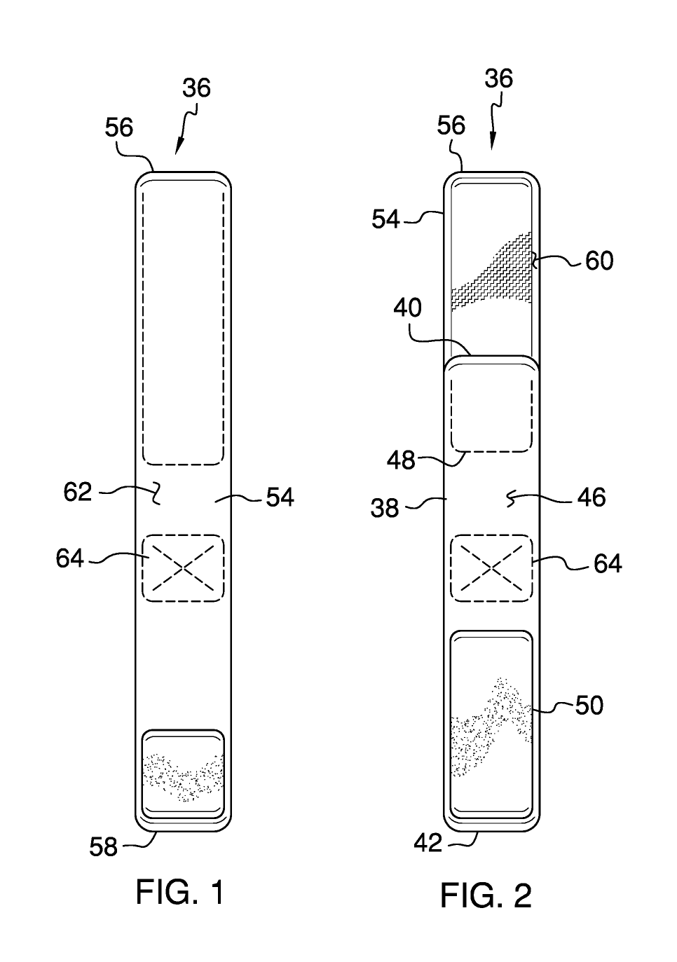

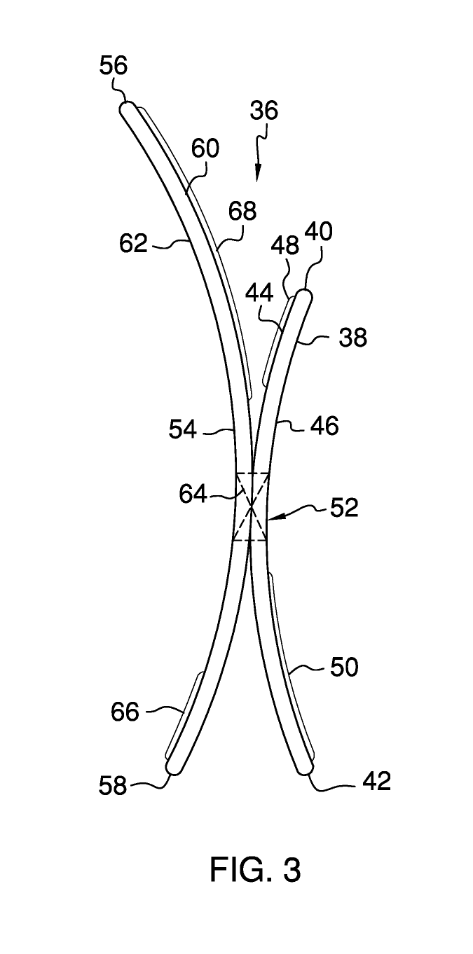

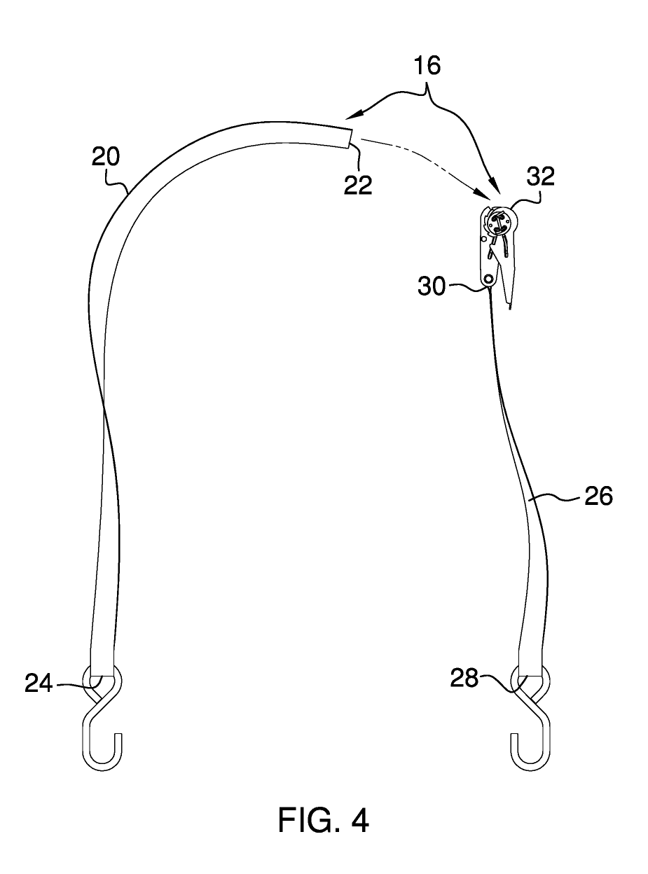

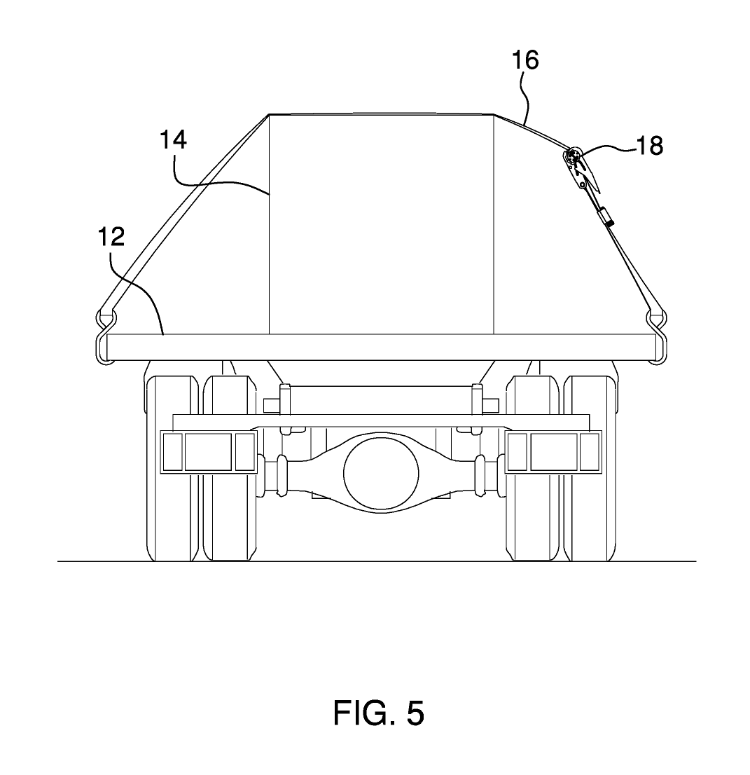

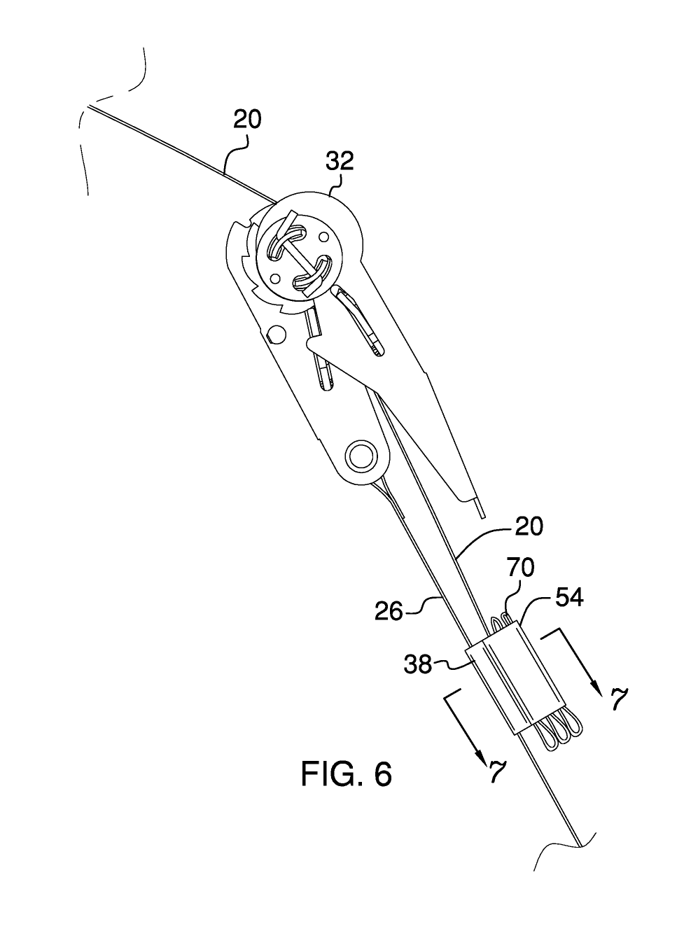

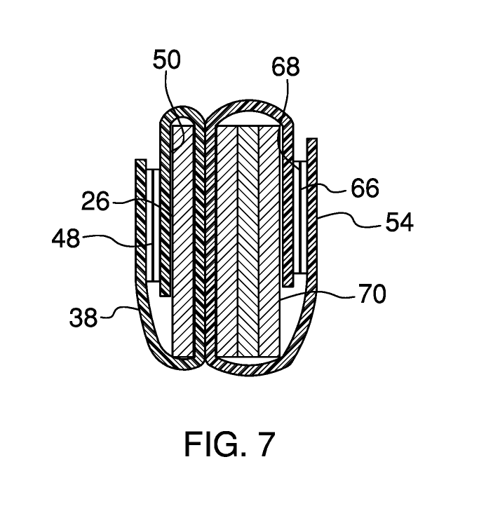

With reference now to the drawings, and in particular to FIGS. 1 through 6 thereof, a new strap device embodying the principles and concepts of an embodiment of the disclosure and generally designated by the reference numeral 10 will be described.

As best illustrated in FIGS. 1 through 6, the cargo strap system 10 generally comprises a vehicle 12. The vehicle 12 may support an object 14 thereby facilitating the object 14 to be transported. Moreover, the term “vehicle” is being used generally as any type of conveyance used for transporting an object which may be strapped down. As such, the vehicle 12 may include motorized vehicles such as trucks and cars or trailers being pulled by such, or any other vehicle 12 commonly used to transport objects. The object 14 may be any transportable article.

At least one cargo strap 16 is provided. The at least one cargo strap 16 is removably coupled to the vehicle 12. Moreover, the at least one cargo strap 16 is selectively extended over the object 14 thereby securing the object 14 to the vehicle 12. The at least one cargo strap 16 may be a ratcheting cargo strap of any conventional design. The at least one cargo strap 16 has a free end 18 when the at least one cargo strap 16 is extended over the object 14.

The at least one cargo strap 16 comprises a first strap 20 that has a first end 22 and a second end 24. The first end 22 is selectively matable to the vehicle 12. The at least one cargo strap 16 further comprises a second strap 26. The second strap 26 has a primary end 28 and a secondary end 30. Moreover, the primary end 28 is selectively attached to the vehicle 12.

A ratchet 32, or other strap coupler is provided, which is coupled to the secondary end 30 of the second strap 26 and the ratchet 32 may be manipulated. The second end 24 of the first strap 20 is selectively extended through the ratchet 32. Thus, a loose portion 34 of the first strap 20 is defined that extends away from the ratchet 32. The ratchet 32 selectively tightens the at least one cargo strap 16 over the object 14. In this way, the at least one cargo strap 16 secures the object 14 to the vehicle 12.

A retention unit 36 is provided that is removably coupled to the at least one cargo strap 16. The retention unit 36 selectively engages the free end 18 of the cargo strap 16 to inhibit the free end 18 from hanging loosely when the vehicle 12 is driven. The retention unit 36 comprises a first belt 38 that has a first end 40, a second end 42, a first surface 44 and a second surface 46. The first belt 38 may be comprised of flexible materials such as canvas, leather, plastics or other high strength, bendable materials. Moreover, the first belt 38 may have a length ranging between approximately 15.0 cm and 20.0 cm.

A first coupler 48 is provided. The first coupler 48 is coupled to the first surface 44 of the first belt 38. The first coupler 48 is positioned closer to the first end 40 of the first belt 38 than the second end 42 of the first belt 38. The first coupler 48 may comprise a hook and loop fastener or the like. The first coupler 48 may have a length ranging between approximately 2.0 cm and 4.0 cm. A second coupler 50 is coupled to the second surface 46 of the first belt 38. The second coupler 50 extends substantially between a middle 52 of the first belt 38 and the second end 42 of the first belt 38. The second coupler 50 is complementary with the first coupler 48 to selectively form a closed loop with the first belt 38 having a selectable diameter. The first belt 38 is selectively wrapped around the second strap 26 when the at least one cargo strap 16 is tightened on the vehicle 12. The second coupler 50 may comprise a hook and loop fastener or the like. The second coupler 50 may have a length ranging between 7.0 cm and 10.0 cm.

A second belt 54 is provided having a primary end 56, a secondary end 58, a primary surface 60 and a secondary surface 62. The second belt 54 has a length that is greater than the length of the first belt 38. The second belt 54 may have a length ranging between 25.0 cm and 30.0 cm. The second belt 54 may be comprised a same material as the first belt 38. The first belt 38 is attached to the second belt to define an attachment point and this may be accomplished with stitching 64 that extends through each of the first belt 38 and the second belt 54. However, any conventional manner may be used including adhesives, heat molding, and the like to secure the first belt 38 to the second belt 54. The first belt 38 is coupled to the second belt 54 having the primary surface 60 abutting the first surface 44. The first belt 38 is oriented to be substantially co-linear with the second belt 54. The stitching 64 is substantially centrally positioned on the first belt 38. Additionally, the secondary end 30 of the second belt 54 may be aligned with the second end 42 of the first belt 38.

A third coupler 66 is provided. The third coupler 66 is coupled to the secondary surface 62 of the second belt 54. The third coupler 66 is positioned closer to the secondary end 58 of the second belt 54 than the primary end 56 of the second belt 54. The third coupler 66 may also comprise a hook and loop fastener or the like. The third coupler 66 may have a length ranging between approximately 2.0 cm and 4.0 cm. A fourth coupler 68 is coupled to the primary surface 60. The fourth coupler 68 extends substantially between the stitching 64 and the primary end 56 of the second belt 54. The fourth coupler 68 is complementary with the third coupler 66 to form a closed loop with the second belt 34 having a selectable diameter. The fourth coupler 68 may comprise a hook and loop fastener or the like. The fourth coupler 68 may have a length ranging between 12.0 cm and 15.0 cm.

In use, the object 14 is positioned on the vehicle 12. The first end 22 of the first strap 20 is mated to the vehicle 12 and the primary end 28 of the second strap 26 is mated to the vehicle 12. The second end 24 of the first strap 20 is extended through the ratchet 32 and the ratchet 32 is manipulated in a conventional manner to tighten the at least one cargo strap 16 over the object 14. The first belt 38 is wrapped around the second strap 26. Each of the first coupler 48 and the second coupler 50 are mated together to retain the first belt 38 around the second strap 26. The loose portion 34 of the first strap 20 is bunched together to form a bundle 70. The bundle is positioned on the second strap 26. The second belt 54 is releasably wrapped around the bundle 70. Each of the third coupler 66 and the fourth coupler 68 are mated together to retain the second belt 54 around the bundle 70 to secure the bundle 70 to the second strap 26.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A cargo strap system comprising:
a vehicle being configured to support an object thereby facilitating the object to be transported;
a cargo strap being removably coupled to said vehicle wherein said cargo strap is configured to be extended over the object thereby securing the object to said vehicle, said cargo strap including a first strap and a second strap attached together, said first strap having a first end and a second end, said first end being matable to said vehicle, said second strap having a primary end and a secondary end, said primary end being matable to said vehicle;
a ratchet being attached to said secondary end of said second strap, said first end of said first strap being extended through said ratchet such that said first end defines a free end;
a retention unit being attached to said second strap, said retention unit releasably securing said free end to said second strap to inhibit said free end from hanging loosely from said ratchet; said retention unit comprising:
a first belt being releasably formed into a loop around said second strap, said first belt having a first surface and a second surface facing away from each other; and
a second belt being attached to said first belt having a primary surface and a secondary surface facing away from each other, said primary surface being attached to said first surface, said second belt being releasably formed into a loop and extending around a bunched portion of said first strap adjacent to said free end to inhibit said free end from hanging loosely.

2-8. (canceled)

9. The system according to claim 1, wherein said first and second belts being attached together with stitching extending through each of said first and second belts, said stitching being centrally positioned on said first belt, said secondary end of said second belt being aligned with said second end of said first belt.

10-13. (canceled)

14. A cargo strap system comprising:
a vehicle being configured to support an object thereby facilitating transporting of the object;
a cargo strap being removably coupled to said vehicle wherein said cargo strap is configured to be extended over the object thereby securing the object to said vehicle, said cargo strap including a first strap and a second strap attached together, said first strap having a first end and a second end, said first end being matable to said vehicle, said second strap having a primary end and a secondary end, said primary end being matable to said vehicle;
a ratchet being attached to said secondary end of said second strap, said first end of said first strap being extended through said ratchet such that said first end defines a free end; and
a retention unit being attached to said second strap, said retention unit releasably securing said free end to said second strap to inhibit said free end from hanging loosely from said ratchet, said retention unit including a belt being releasably formed into a loop around said a bunched up portion of said first strap positioned adjacent to said free end to inhibit said free end from said hanging loosely.

15. The cargo strap system according to claim 14, further including a coupler releasably retaining said belt in said loop.

16. The cargo strap system according to claim 15, wherein said coupler comprises a hook and loop coupler.
